(19) United States
(12) Patent Application Publication
(10) Pub. No.: US 2018/0357321 A1
(43) Pub. Date: Dec. 13, 2018

(54) SEQUENTIALIZED BEHAVIOR BASED USER GUIDANCE

(71) Applicant: eBay Inc., San Jose, CA (US)

(72) Inventors: Han Cheng, San Francisco, CA (US); Manojkumar Rangasamy Kannadasan, Fremont, CA (US); Wenwan Yang, San Jose, CA (US)

(21) Appl. No.: 15/617,902

(22) Filed: Jun. 8, 2017

(51) Int. Cl. G06F 17/30; G06Q 30/06; G06N 99/00; G06N 5/04; G06N 3/04

(52) U.S. Cl. CPC G06F 17/30867; G06Q 30/0631; G06N 3/0445; G06N 99/005; G06N 5/04; G06Q 30/0643

(57) ABSTRACT

Aspects of the present disclosure relate to a network-based, user behavior based guidance system that includes a client device in communication with an application server executing the system over a network. For example, the user behavior based guidance system may be or include a group of one or more server machines. The user behavior based guidance system is configured to collect user behavior data of users interacting within a network during browsing sessions. For example, the user behavior collected by the system in a browsing session of the user includes clicks, back clicks, dwell time, device type, search requests, as well as exit rate. Each browsing session may be treated as a sequence of states, wherein each user behavior event is treated as a state in the sequence.

### TECHNICAL FIELD

The subject matter of the present disclosure generally relates to user interfaces for client devices. In particular, example embodiments relate to a system to contextualize and personalize user interfaces based on user behavior data.

### BACKGROUND

A variety of methods are known for generating and displaying contextualized user interfaces at client devices. For example, systems may access user profile data that includes purchase histories or item viewing histories of users, analyze the user profile data, and determine associations between particular items represented in an electronic catalog. Similarly, the web browsing histories of users can be analyzed to identify behavior-based associations between particular web sites and/or web pages.

### BRIEF DESCRIPTION OF THE DRAWINGS

Various ones of the appended drawings merely illustrate example embodiments of the present disclosure and are not intended to limit its scope to the illustrated embodiments. On the contrary, these examples are intended to cover alternatives, modifications, and equivalents as may be included within the scope of the disclosure.

FIG. 1 is a block diagram illustrating an example of a software architecture that may be installed on a machine, according to some example embodiments.

FIG. 2 is a block diagram illustrating various functional components of a behavior sequentialization system, which is provided as part of the networked system, according to example embodiments.

FIG. 3 is a flow chart illustrating a method for generating a predicted recommendation based on a behavioral model, according to an example embodiment.

FIG. 4 is a flow chart illustrating a method for generating a predicted recommendation based on a behavioral model, according to an example embodiment.

FIG. 5 is an interface diagram illustrating a graphical user interface that includes presentations of predicted recommendations, according to an example embodiment.

FIG. 6 is a flow chart illustrating a method 600 for generating predicted recommendations for a user, based on a trained behavioral model, according to an example embodiment.

FIG. 7 is a block diagram illustrating an architecture of software, which can be installed on any one or more of the devices described herein, according to an example embodiment.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

Reference will now be made in detail to specific example embodiments for carrying out the inventive subject matter of the present disclosure. In the following description, specific details are set forth in order to provide a thorough understanding of the subject matter. It shall be appreciated that embodiments may be practiced without some or all of these specific details.

A common problem in the technical field of generating and displaying user interfaces is the allocation of display space on display screens of client devices. As client devices decrease in size, so does usable display space on display screen of the client devices. As a result, it is often difficult to determine exactly what information should be displayed, and what information should be disregarded and removed from a presentation. Thus, a system which may aggregate user behavior of one or more users, predict a user browsing path based on the user behavior, and to generate and cause display of user interface elements in a display based on the predicted user browsing path would prove to be an improvement in the field.

Aspects of the present disclosure relate to a network-based, user behavior based guidance system that includes a client device in communication with an application server executing the system over a network. For example, the user behavior based guidance system may be or include a group of one or more server machines. The user behavior based guidance system is configured to collect user behavior data of users interacting within a network during browsing sessions. For example, the user behavior collected by the system in a browsing session of the user includes clicks, back clicks, dwell time, device type, search requests, as well as exit rate. Each browsing session may be treated as a sequence of states, wherein each user behavior event is treated as a state in the sequence.

In some example embodiments, the user behavior based guidance system generates and assigns a timestamp to each event (e.g., user behavior) in a session. The timestamps may indicate a specific time and date in which an event in a session occurred, or simply indicate a temporal location of the event in the sequence (e.g., numerically). For example, the events may be timestamped with a time (e.g., 1:01 AM), or simply be numbered in sequence (e.g., event 5).

In some example embodiments, the user behavior based guidance system may filter out “unnecessary” user behavior data from among the user behavior data collected. For example, the system may identify only events from among the user behavior data that resulted in a transition from one state to another, and disregard user behaviors wherein the user browsing session remains in the same state.

The user behavior based guidance system vectorizes the sequentialized user behavior data. For example, to vectorize the user behavior data, the system may populate a matrix with the user behavior data, and apply a linear transformation to the matrix of the user behavior data, converting the matrix into a column vector. The system may train a Long Short-Term Memory (LSTM) model based on the vectorized user behavior data.

In some example embodiments, the system for sequentialized behavior based guidance may additionally utilize user affinity data that includes user profile data (e.g., user preferences, past user purchase behavior) to train the model to predict recommendations for the user. For example, the system for sequentialized behavior based guidance may populate a matrix with both the sequentialized user behavior data as well as the user affinity data, and vectorize the matrix.

During a model training phase, a sequence of events (e.g., from a user browsing session) is used to train the LSTM model. The trained LSTM model generates and outputs a predicted sequence of events based on the user behavior data. For example, the user behavior based guidance system may pass a single event, or a sequence of events to the LSTM model, which may output a set of probabilities of possible “next” session states. The trained. LSTM model predicts the probability of a “next” state given a current state, and user behavior data collected over a predefined period of time. For example, the user behavior data may be collected from a previous browsing session, over a week, or over the entire user behavior history of a user. The LSTM model can thereby adjust the state predictions based on the user behavior of the user.

In some example embodiments, the system may cause display of a set of user selectable options representative of the predicted recommendations, while in further example embodiments, the system may alter or otherwise adjust a presentation of an interface based on the predicted user states. For example, the system may alter a presentation of a set of user selectable search options based on the predicted user states.

Consider an illustrative example from a user perspective. A user may interact with a networked-system during a first browsing session. The system for sequentialized behavior based guidance may collect the user behavior data of the user during the browsing session, filter unnecessary user actions from the user behavior data, and sequentialize the filtered user behavior data based on time stamps. The system populates a matrix with the user behavior data, vectorizes the matrix, and trains a behavioral model (e.g., LSTM model) based on the vectorized behavior data. The trained model may thereby receive user behavior events in a second browsing session as inputs, and output one or more predicted recommendations for the user based on the user behavior event.

In a second browsing session, the system collected user behavior data from the current session, filters and sequentializes the user behavior data, and passes the user behavior data to the trained behavioral model. The model may output one or more predicted recommendations based on the user behavior data, wherein the predicted recommendations may include a set of one or more search filters, one or more item listings, or in some example embodiments may alter a presentation of a search interface to highlight some fields while de-emphasizing others. For example, the system may receive a user behavior event that includes a search request comprising a search term “CELL PHONES.” In response to receiving the user behavior event (e.g., the search request), the system passes the user behavior event to the model which outputs a predicted recommendation for the user, based on the user behavior event. In this instance, the predicted recommendation may cause the system to alter a presentation of a search results page to de-emphasize item listings for one type of cell phone (e.g., SONY), while emphasizing a set of item listings for another type of cell phone (e.g., APPLE).

In further embodiments, the predicted recommendations may include a set of search filters determined based on the past user behavior data. For example, the trained model may determine that the user rarely views flip phones in search results, and prefers touch screen phones based on past behavior data. The system may thereby alter a display order of a set of search results based on the predicted recommendation.

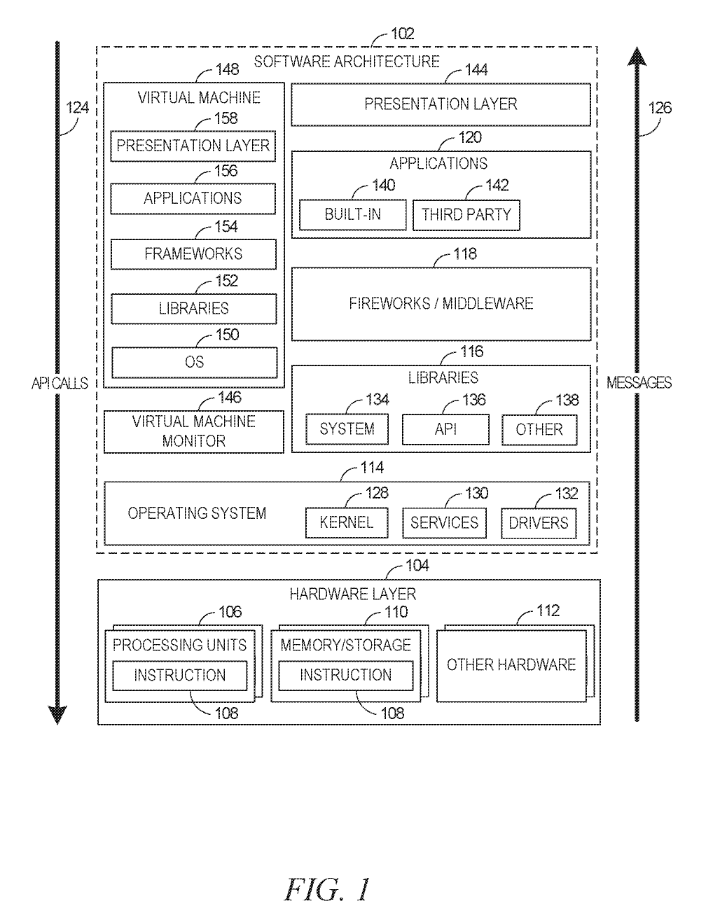

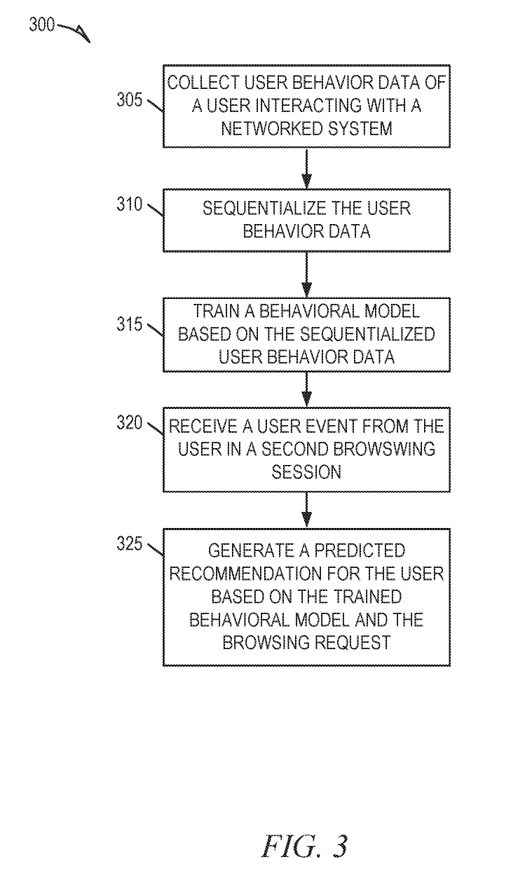

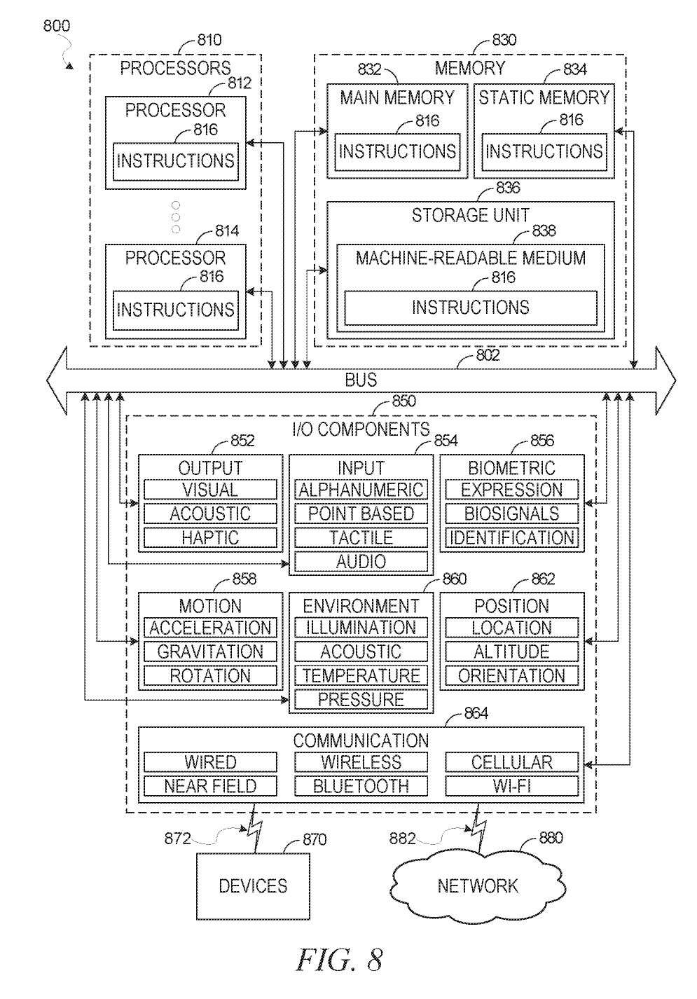

FIG. 1 is a block diagram illustrating an example of a software architecture that may be installed on a machine, according to some example embodiments. FIG. 1 is merely a non-limiting example of a software architecture, and it will be appreciated that many other architectures may be implemented to facilitate the functionality described herein. The software architecture 102 may be executing on hardware such as a machine 800 of FIG. 8 that includes, among other things, processors 810, memory 830, and I/O components 850. A representative hardware layer 104 is illustrated and can represent, for example, the machine 800 of FIG. 8. The representative hardware layer 104 comprises one or more processing units 106 having associated executable instructions 108. The executable instructions 108 represent the executable instructions of the software architecture 102, including implementation of the methods, modules, and so forth of FIGS. 3-6. The hardware layer 104 also includes memory or storage modules 110, which also have the executable instructions 108. The hardware layer 104 may also comprise other hardware 112, which represents any other hardware of the hardware layer 104, such as the other hardware illustrated as part of the machine 100.

In the example architecture of FIG. 1, the software architecture 102 may be conceptualized as a stack of layers, where each layer provides particular functionality. For example, the software architecture 102 may include layers such as an operating system 114, libraries 116, frameworks/middleware 118, applications 120, and a presentation layer 1044. Operationally, the applications 120 or other components within the layers may invoke API calls 124 through the software stack and receive a response, returned values, and so forth (illustrated as messages 126) in response to the API calls 124. The layers illustrated are representative in nature, and not all software architectures have all layers. For example, some mobile or special purpose operating systems may not provide a frameworks/middleware 118 layer, while others may provide such a layer. Other software architectures may include additional or different layers.

The operating system 114 may manage hardware resources and provide common services. The operating system 114 may include, for example, a kernel 128, services 130, and drivers 132. The kernel 128 may act as an abstraction layer between the hardware and the other software layers. For example, the kernel 128 may be responsible for memory management, processor management (e.g., scheduling), component management, networking, security settings, and so on. The services 130 may provide other common services for the other software layers. The drivers 132 may be responsible for controlling or interfacing with the underlying hardware. For instance, the drivers 132 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 116 may provide a common infrastructure that may be utilized by the applications 120 and/or other components and/or layers. The libraries 116 typically provide functionality that allows other software modules to perform tasks in an easier fashion than by interfacing directly with the underlying operating system 114 functionality (e.g., kernel 128, services 130, or drivers 132). The libraries 116 may include system 134 libraries (e.g., C standard library) that may provide functions such as memory allocation functions, string manipulation functions, mathematic functions, and the like. In addition, the libraries 116 may include API libraries 136 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 116 may also include a wide variety of other libraries 138 to provide many other APIs to the applications 120 and other software components/modules.

The frameworks 118 (also sometimes referred to as middleware) may provide a higher-level common infrastructure that may be utilized by applications 120 or other software components/modules. For example, the frameworks 118 may provide various graphic user interface (GUI) functions, high-level resource management, high-level location services, and so forth. The frameworks 118 may provide a broad spectrum of other APIs that may be utilized by the applications 120 and/or other software components/modules, some of which may be specific to a particular operating system or platform.

The applications 120 include built-in applications 140 and/or third party applications 142. Examples of representative built-in applications 140 may include, but are not limited to, a contacts application, a browser application, a book reader application, a location application, a media application, a messaging application, or a game application. The third party applications 142 may include any of the built-in applications, as well as a broad assortment of other applications. In a specific example, the third party application 142 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 142 may invoke the API calls 124 provided by the mobile operating system such as the operating system 114 to facilitate functionality described herein.

The applications 120 may utilize built-in operating system functions (e.g., kernel 128, services 130, or drivers 132), libraries (e.g., system 134, APIs 136, and other libraries 138), or frameworks/middleware 118 to create user interfaces to interact with users of the system. Alternatively, or additionally, in some systems, interactions with a user may occur through a presentation layer, such as the presentation layer 144. In these systems, the application/module “logic” can be separated from the aspects of the application/module that interact with the user.

Some software architectures utilize virtual machines. In the example of FIG. 1, this is illustrated by a virtual machine 148. A virtual machine creates a software environment where applications/modules can execute as if they were executing on a hardware machine e.g., the machine 100 of FIG. 1, for example). A virtual machine is hosted by a host operating system (e.g., operating system 114) and typically, although not always, has a virtual machine monitor 146, which manages the operation of the virtual machine as well as the interface with the host operating system (e.g., operating system 114). A software architecture executes within the virtual machine 148, such as an operating system 150, libraries 152, frameworks/middleware 154, applications 156, or a presentation layer 158. These layers of software architecture executing within the virtual machine 148 can be the same as corresponding layers previously described or may be different.

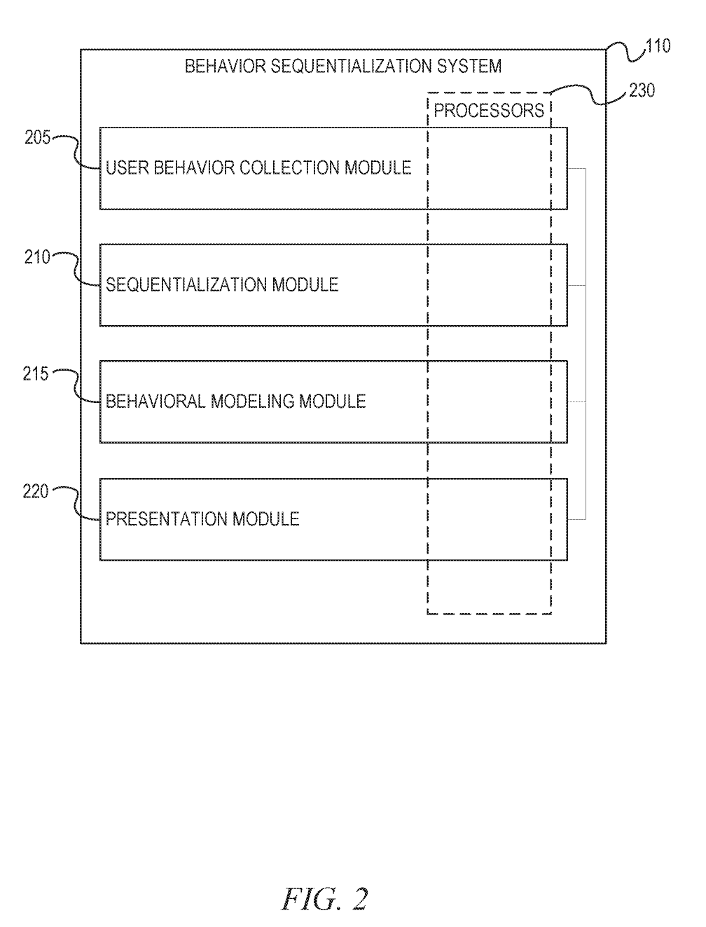

FIG. 2 is a block diagram illustrating components of a behavior sequentialization system 110 that configure the behavior sequentialization system 110 to predict user behavior based on sequentialized past user behavior, according to some example embodiments. The behavior sequentialization system 110 is shown as including a user behavior collection module 205, a sequentialization module 210, a behavioral modeling module 215, and a presentation module 220, all configured to communicate with each other (e.g., via a bus, shared memory, or a switch). Any one or more of these modules may be implemented using one or more processors 230 (e.g., by configuring such one or more processors to perform functions described for that module) and hence may include one or more of the processors 230.

Any one or more of the modules described may be implemented using dedicated hardware alone (e.g., one or more of the processors 230 of a machine) or a combination of hardware and software. For example, any module described of the behavior sequentialization system 110 may physically include an arrangement of one or more of the processors 230 (e.g., a subset of or among the one or more processors of the machine) configured to perform the operations described herein for that module. As another example, any module of the behavior sequentialization system 110 may include software, hardware, or both, that configure an arrangement of one or more processors 230 (e.g., among the one or more processors of the machine) to perform the operations described herein for that module. Accordingly, different modules of the behavior sequentialization system 110 may include and configure different arrangements of such processors 230 or a single arrangement of such processors 230 at different points in time. Moreover, any two or more modules of the behavior sequentialization system 110 may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 3 is a flow chart illustrating a method 300 for generating a predicted recommendation for a user based on a behavioral model, according to an example embodiment. The method 300 may be embodied in computer-readable instructions for execution by one or more processors (e.g., processors 230 of FIG. 2) such that the steps of the method 300 may be performed in part or in whole by functional components (e.g., modules) of a client device or the behavior sequentialization system 110; accordingly, the method 300 is described below by way of example with reference thereto. However, it shall be appreciated that the method 300 may be deployed on various other hardware configurations and is not intended to be limited to the functional components of the client device or the behavior sequentialization system 110.

At operation 305, the user behavior collection module 205 collects user behavior data of a user interacting with a networked system. The user behavior collection module 205 may generate a log that records all of a user's past user behavior data of the user interacting with the networked system. For example, the user behavior data may include events such as clicks, an exit rate, back clicks, dwell time, search requests, as well as a device type. In some example embodiments, the user behavior collection module 205 may time stamp each of the events based on a time in which the event occurred, or in some embodiments, a relative position of the event in a sequence of events that make up a browsing session. At operation 310, the sequentialization module 210 sequentializes the user behavior data based on the time stamps.

At operation 315, the behavior modeling module 220 trains a behavioral model based on the sequentialized user behavior data. For example, the behavioral model may include an LSTM model. An LSTM is a Recurrent Neural Network (RNN), configured to classify, process, and predict time series. The behavior modeling module 220 may train the LSTM model through a combination of artificial evolution for weights to the hidden units, and pseudo-inverse or support vector machines for weights to the output units. In some example embodiments, the LSTM may be trained by policy gradient methods, evolution strategies, or genetic algorithms.

Having trained the LSTM model, at operation 320, the user behavior collection module 205 receives a user input that includes a user event (e.g., user behavior data) from a client device of the user. For example, as discussed above, the user event may include a search request from the user, a selection of a graphical icon within an interface, as well as a back click or forward click to transition from one page to another.

At operation 325, the behavioral modeling module 215 receives the user behavior data from the user behavior collection module 205, and generates a predicted recommendation for the user based on the trained model. For example, the behavioral modeling module 215 may calculate probabilities of actions that the user may perform based on the past user behavior data. The presentation module 220 thereby generates and causes display of a predicted recommendation for the user based on the user behavior data. For example, the predicted recommendation may include one or more search filter recommendations, a set of item listings, or in some example embodiments, the presentation module 220 may alter a presentation of a an interface displayed at a client device of the user, based on the predicted recommendation. For example, the presentation module 220 may highlight or de-emphasize portions of the interface.

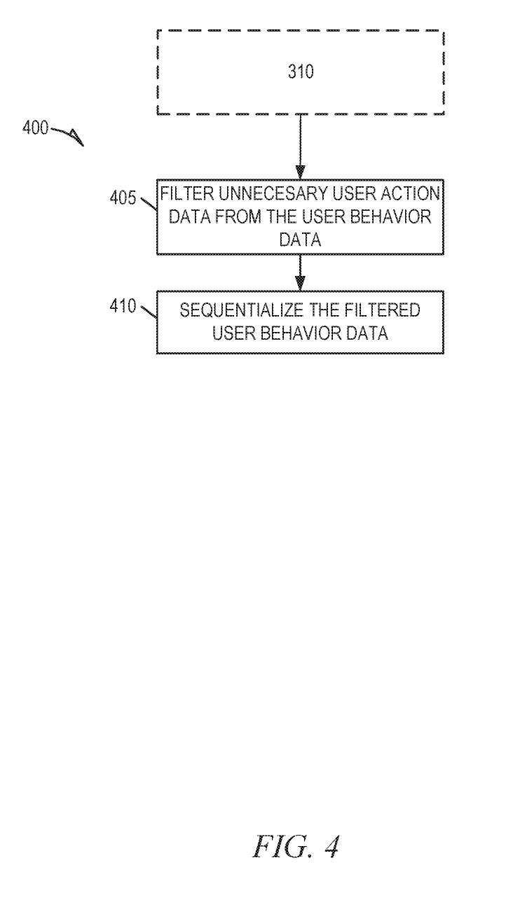

FIG. 4 is a flow chart illustrating a method 400 for generating a predicted recommendation based on a behavioral model, according to an example embodiment, according to an example embodiment. The method 400 may be embodied in computer-readable instructions for execution by one or more processors (e.g., processors 230) such that the steps of the method 400 may be performed in part or in whole by functional components (e.g., modules) of a client device or the behavior sequentialization system 110; accordingly, the method 400 is described below by way of example with reference thereto. However, it shall be appreciated that the method 400 may be deployed on various other hardware configurations and is not intended to be limited to the functional components of a client device or the behavior sequentialization system 110.

One or more operations 405, 410, and 415 of the method 400 may be performed as part (e.g., a precursor task, a subroutine, or portion) of operation 310 of the method 300, in which the sequentialization module 210 sequentializes the user behavior data, according to some example embodiments.

At operation 405, the sequentialization module 210 filters unnecessary user action data from the user behavior data collected by the user behavior collection module 205. For example, the sequentialization module 210 may analyze the user behavior data and identify a sequence of user events among the user behavior data that result in a transition from one page to another, and disregard user event data that does not result in a transition.

At operation 410, the sequentialization module 210 sequentializes the filtered user behavior data based on time stamps associated with user events among the user behavior data.

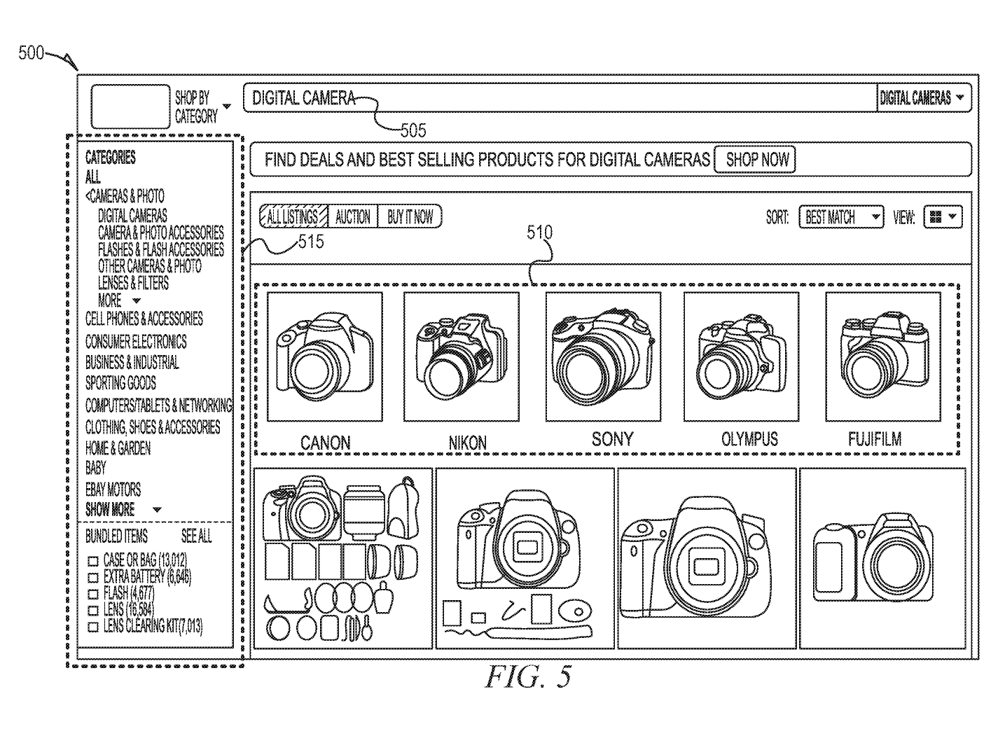

FIG. 5 is an interface diagram illustrating a graphical user interface 500 that includes presentations of predicted recommendations 510 and 515 by a behavioral model trained by the behavior sequentialization system 110, according to an example embodiment.

As discussed above with respect to FIG. 3, the behavior sequentialization system 110 aggregates user behavior data of one or more users, sequentializes the user behavior data, and trains a behavioral model based on the sequentialized user behavior data. The trained behavioral model may thereby receive user event data (e.g., search requests, browsing requests), and based on the user event data, generate one or more predicted recommendations for the user. The one or more predicted recommendations may for example include a recommended browsing path, or in some embodiments, may include altering a presentation of a set of search results or interface elements, based on the predicted browsing path of the user.

For example, the sequentialization system 110 may detect a user event, such as a user providing a search request 505 through the graphical user interface 500 resulting in a presentation of a set of search results. Based on the user event, the trained behavioral model may predict one or more browsing paths that the user may take. For example, the trained behavioral model may determine that based on past user behavior data, the user is likely to narrow the search request with the addition of one or more search filters. The behavioral model may cause display of the predicted recommendations 510 and 515, wherein the predicted recommendations 510 and 515 include the one or more search filters most likely selected by the user.

In some example embodiments, the sequentialization system 110 may adjust or otherwise alter the graphical user interface 500, based on the one or more predicted recommendations for the user. For example, the sequentialization system 110 may reorganize a set of links or graphical elements presented in the graphical user interface 500 based on the user behavior data.

For example, the set of predicted recommendations 510 include a set of graphical elements associated with search filters (e.g., filter by brand). The sequentialization system 110 may determine that based on the aggregated user behavior data, the user is more likely to select some of the search filters than others (e.g., most likely to select CANON or NIKON). The sequentialization system 110 may thereby adjust the presentation of the search filters based on the determination, such that the most likely selected filter is presented first. In further embodiments, the sequentialization system 110 may determine that a user very rarely, or never selects particular search filters. In such embodiments, the sequentialization system 110 may remove the search filters from among the presentation of search filters.

Similarly, the set of predicted recommendations 515 includes a listing of item categories (e.g., consumer electronics, sporting goods, etc.). In some example embodiments, the sequentialization system 110 may alter or remove item listings from among the listing of item listings based on the aggregated user behavior data. For example, item categories more often selected by the user may be promoted in the listings, while item categories selected less frequently may be demoted or removed entirely.

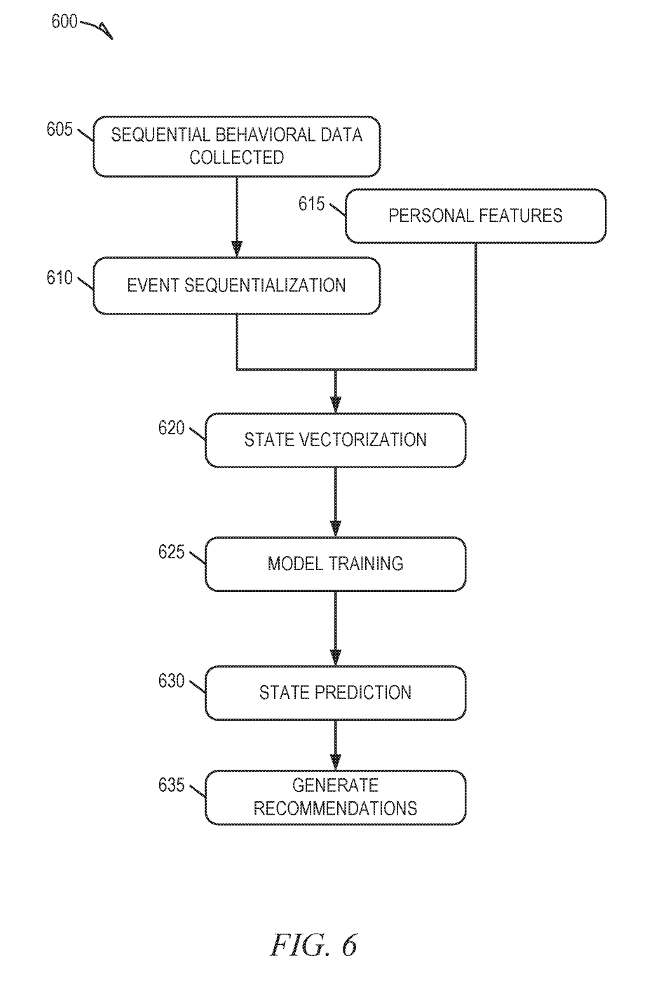

FIG. 6 is a flow chart illustrating a method 600 for generating predicted recommendations for a user, based on a trained behavioral model, according to an example embodiment. The method 600 may be embodied in computer-readable instructions for execution by one or more processors (e.g., processors 230) such that the steps of the method 600 may be performed in part or in whole by functional components (e.g., modules) of a client device or the behavior sequentialization system 110; accordingly, the method 600 is described below by way of example with reference thereto. However, it shall be appreciated that the method 500 may be deployed on various other hardware configurations and is not intended to be limited to the functional components of the client device or the behavior sequentialization system 110.

At operation 605, the user behavior collection module 205 collects behavioral data of one or more users. For example, in some example embodiments, the user behavior collection module 205 may collect user behavior data from a single user, and store the user behavior data at a memory location associated with the user within a database. In further embodiments, the user behavior collection module 205 may collect and store the user behavior data at memory locations within the database based on demographics data associated with the one or more users. For example, the database may include various memory locations based on demographics details of users within a networked system, such as age, sex, gender, purchasing behavior, occupation, as well as user profile information, such as user affinities.

At operation 610, the sequentialization module 210 sequentializes the user behavior data based on time stamps within the data. In some example embodiments, the sequentialization module 210 filters unnecessary user actions from among the user behavior data, and sequentializes the filtered user behavior data.

At operation 615, the sequentialization module 210 retrieves personal features, including user profile data of one or more users associated with the user behavior data, and populates a matrix with the user profile data and the sequentialized user behavior data.

At operation 620, the sequentialization module 210 vectorizes the populated matrix, and at operation 625, delivers the vectorized matrix to the behavioral modeling module 215 to train a behavioral model (e.g., an LSTM model).

At operation 630, the user behavior collection module 205 receives a user input, such as user event data. In response, the behavioral modeling module 215 predicts probabilities of one or more possible transitions that the user may perform, based on the trained behavioral model and the user input.

At operation 635, the behavioral modeling module 215 generates one or more predicted recommendations for the user, and the presentation module 220 causes display of the predicted recommendations at a client device.

### Machine Architecture

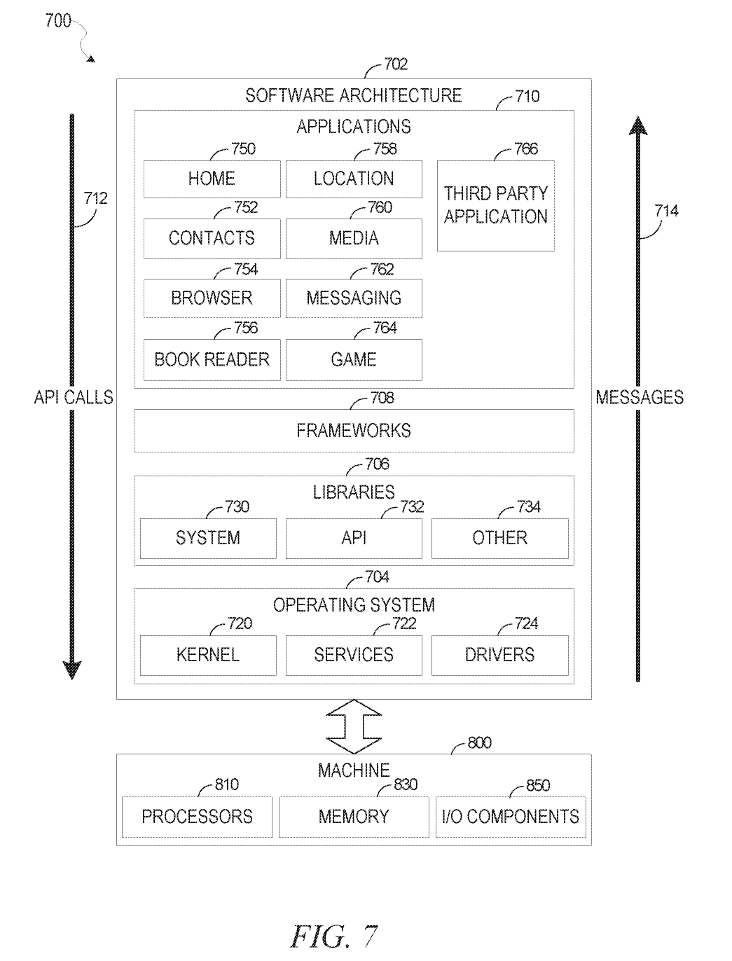

FIG. 7 is a block diagram 700 illustrating an architecture of software 702, which can be installed on any one or more of the devices described above. FIG. 7 is merely a non-limiting example of a software architecture, and it will be appreciated that many other architectures can be implemented to facilitate the functionality described herein. In various embodiments, the software 702 is implemented by hardware such as a machine 700 of FIG. 7 that includes processors 810, memory 830, and I/O components 850. In this example architecture, the software 702 can be conceptualized as a stack of layers where each layer may provide a particular functionality. For example, the software 702 includes layers such as an operating system 704, libraries 706, frameworks 708, and applications 710. Operationally, the applications 710 invoke application programming interface (API) calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphic user interface (GUI) functions, high-level resource management, high-level location services, and so forth. The frameworks 708 can provide a broad spectrum of other APIs that can be utilized by the applications 710, some of which may be specific to a particular operating system or platform.

In an example embodiment, the applications 710 include a home application 750, a contacts application 752, a browser application 754, a book reader application 756, a location application 758, a media application 760, a messaging application 762, a game application 764, and a broad assortment of other applications such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an apples, an app, or other executable code) for causing the machine 800 to perform any one or more of the methodologies discussed herein may be executed. For example the instructions 816 may cause the machine 800 to execute the method 800 of FIG. 8. Additionally, or alternatively, the instructions 816 may implement FIGS. 3-6, and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions contemporaneously. Although FIG. 8 shows multiple processors, the machine 800 may include a single processor with a single core, a single processor with multiple cores (e.g., a multi-core processor), multiple processors with a single core, multiple processors with multiples cores, or any combination thereof.

The memory 830 may include a main memory 832, a static memory 834, and a storage unit 836, both accessible to the processors 810 such as via the bus 802. The main memory 830, the static memory 834, and storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include Radio Frequency Identification (RFID) tag reader components, NFC smart tag detection components, optical reader components e an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 830, 832, 834, and/or memory of the processor(s) 810) and/or storage unit 836 may store one or more sets of instructions and data structures (e.g., software) embodying or utilized by any one or more of the methodologies or functions described herein. These instructions, when executed by processor(s) 810 cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically exclude carrier waves, modulated data signals, and other such media, at least some of which are covered under the term “signal medium” discussed below.

### Transmission Medium

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method comprising:
collecting user behavior data of a user interacting with a networked system in a first browsing session, the user behavior indicating a browsing path of the user within the networked system in the first browsing session;
sequentializing the user behavior data of the user;
identifying a sequential browsing pattern of the user based on the sequentialized user behavior data;
receiving a browsing request from the user in a second browsing session; and
generating a recommended browsing path for the user based on the sequential browsing pattern and the browsing request.

2. The method of claim 1, wherein the user behavior data includes a set of time stamps, and the sequentializing the user behavior data includes:
filtering unnecessary user action data from the user behavior data; and
sequentializing the filtered user behavior data of the user based on the time stamps.

3. The method of claim 1, wherein the method further comprises:
training a predictive model based on the sequentialized user behavior data of the user; and
wherein the generating the recommended browsing path for the user is based on the predictive model.

4. The method of claim 3, wherein the predictive model is a Long-Short Term Memory Model.

5. The method of claim 3, wherein the predictive model is a Recurrent Neural Network trained model.

6. The method of claim 1, wherein the user behavior data of the user includes an exit rate of the user, back clicks of the user, device type, and dwell time.

7. The method of claim 1, wherein the browsing request from the user includes a search request, and wherein the generating the recommended browsing path includes:
causing display of a set of recommended search filters.

8. The method of claim 1, wherein the generating the recommended browsing path includes:
determining a current state of the user in the second browsing session; and
predicting the recommended browsing path of the user based on the current state and the sequential browsing pattern of the user.

9. The method of claim 1, wherein the generating the recommended browsing path includes:
retrieving user profile data of the user in response to the receiving the browsing request;
vectorizing the user profile data of the user and the filtered user behavior data; and
generating the recommended browsing path based on the vectorized user profile data and filtered user behavior data.

10. A non-transitory machine-readable storage medium, storing instructions which, when executed by at least one processor of a machine, cause the machine to perform operations comprising:
collecting user behavior data of a user interacting with a networked system in a first browsing session, the user behavior indicating a browsing path of the user within the networked system in the first browsing session;
sequentializing the user behavior data of the user;
identifying a sequential browsing pattern of the user based on the sequentialized user behavior data;
receiving a browsing request from the user in a second browsing session; and
generating a recommended browsing path for the user based on the sequential browsing pattern and the browsing request.

11. The non-transitory machine-readable storage medium of claim 10, wherein the instructions cause the machine to perform operations further comprising:
time-stamping the user behavior data;
filtering unnecessary user action data from the user behavior data; and
sequentializing the filtered user behavior data of the user based on the time stamps.

12. The non-transitory machine-readable storage medium of claim 10, wherein the instructions cause the machine to perform operations further comprising:
training a predictive model based on the sequentialized user behavior data of the user; and
wherein the generating the recommended browsing path for the user is based on the predictive model.

13. The non-transitory machine-readable storage medium of claim 10, wherein the predictive model is a Long-Short Term Memory Model.

14. The non-transitory machine-readable storage medium of claim 10, wherein the predictive model is a Recurrent Neural Network trained model.

15. The non-transitory machine-readable storage medium of claim 10, wherein the user behavior data of the user includes an exit rate of the user, back clicks of the user, device type, and dwell time.

16. The non-transitory machine-readable storage medium of claim 10, wherein the browsing request from the user includes a search request, and wherein the generating the recommended browsing path includes:
causing display of a set of recommended search filters.

17. The non-transitory machine-readable storage medium of claim 10, wherein the generating the recommended browsing path includes:
determining a current state of the user in the second browsing session; and
predicting the recommended browsing path of the user based on the current state and the sequential browsing pattern of the user.

18. The non-transitory machine-readable storage medium of claim 10, wherein the generating the recommended browsing path includes:
retrieving user profile data of the user in response to the receiving the browsing request;
vectorizing the user profile data of the user and the filtered user behavior data; and
generating the recommended browsing path based on the vectorized user profile data and filtered user behavior data.

19. A system comprising:
one or more processors of a machine; and
a memory storing instructions that, when executed by at least one processor among the one or more processors, causes the machine to perform operations comprising:
collecting user behavior data of a user interacting with a networked system in a first browsing session, the user behavior indicating a browsing path of the user within the networked system in the first browsing session;
sequentializing the user behavior data of the user;
identifying a sequential browsing pattern of the user based on the sequentialized user behavior data;
receiving a browsing request from the user in a second browsing session; and
generating a recommended browsing path for the user based on the sequential browsing pattern and the browsing request.

20. The system of claim 19, wherein the operations further comprise:
training a predictive model based on the sequentialized user behavior data of the user; and
wherein the generating the recommended browsing path for the user is based on the predictive model.
